(19) United States
(12) Patent Application Publication
(10) Pub. No.: US 2009/0084408 A1
(43) Pub. Date: Apr. 2, 2009

(54) Method of Cleaning Cavities on Gas Turbine Components

(76) Inventor: Karl Georg Thiemann, Hannover (DE)

Correspondence Address: Davidson, Davidson & Kappel, LLC, 485 7th Avenue, 14th Floor, New York, NY, 10018, US

(21) Appl. No.: 11/992,439

(22) PCT Filed: Sep. 16, 2006
(86) PCT No.: PCT/DE2006/001634

§ 371 Date: Mar. 20, 2008

(30) Foreign Application Priority Data
Sep. 24, 2005 (DE) 10 2005 045 839.4

(51) Int. Cl. B08B 3/10

(52) U.S. Cl. 134/19

(57) ABSTRACT

A method of cleaning cavities on gas turbine components, in particular on gas turbine blades, wherein a caustic cleaning medium and subsequently a rinsing medium are directed for this purpose in particular repeatedly through the or each cavity, to be cleaned, of a gas turbine component is disclosed. Before the treatment of the or each cavity with cleaning medium and rinsing medium, the or each cavity of the gas turbine component is flooded with inert gas. The gas turbine component, with the inert gas atmosphere in the or each cavity being maintained, is then subjected to a preferably repetitive thermal treatment, wherein the component is heated for this purpose in a first time interval, is held at this temperature for a second time interval and is then cooled in a third time interval. The cleaning medium and the rinsing medium are then directed through the or each cavity.

The present invention relates to a method for cleaning cavities on gas turbine components, in particular on gas turbine blades, according to the definition of the species set forth in claim 1.

During gas turbine operation, impurities can deposit or settle in the cavities of gas turbine components, thus, for example, in the cavities of internally cooled gas turbine rotor blades. When performing maintenance on gas turbines, X-ray techniques can be employed to detect such deposits in the cavities of gas turbine components, when it is ascertained that such deposits or impurities are present in the cavities of the gas turbine components, it being necessary to remove them from the cavities. Special cleaning methods are used for this purpose.

To clean the cavities on gas turbine components, it is already known from the related art, namely from U.S. Pat. No. 5,618,353, to direct a heated, caustic cleaning medium through the cavities, following the cleaning medium, a rinsing medium being directed through the cavities. If such a method is used for cleaning cavities on gas turbine components, the requirements in terms of targeted cleaning efficiency are satisfied for approximately 90% of the cleaned components. On the other hand, 10% of the cleaned components do not meet the requirements. This is especially true when the gas turbine, whose components are to be cleaned, has been operated under extreme environmental conditions. This applies to gas turbine aircraft engines that have been operated under hot, as well as sandy conditions. In such a case, an effective cleaning of cavities on gas turbine components is not possible using the method known from the related art.

Against this background, an object of the present invention is to devise a novel method for cleaning cavities on gas turbine components, in particular on gas turbine blades.

This objective is achieved by a method for cleaning cavities on gas turbine components, in particular on gas turbine blades, as set forth in claim 1. In accordance with the present invention, prior to treating the or each cavity with a cleaning medium and rinsing medium, the or each cavity of the gas turbine component is flooded with inert gas, the gas turbine component subsequently undergoing a thermal treatment, preferably repeatedly, while the inert gas atmosphere is maintained in the or each cavity, to this end, the component being heated for a first time interval to a temperature, maintained at this temperature for a second time interval, and subsequently cooled in a third time interval, and, only subsequently thereto, the cleaning medium and rinsing medium being directed through the or each cavity.

By subjecting the component to the thermal treatment in accordance with the present invention prior to introducing the cleaning medium, as well as the rinsing medium into the or each cavity, it is possible to break up impurities and deposits in the cavities, allowing them to be effectively removed from the or each cavity when the or each cavity is subsequently flushed with cleaning medium and rinsing medium. Once the method according to the present invention is used to clean the gas turbine components in the region of the cavities thereof, 100% of all of the cleaned components meet the targeted cleaning efficiency requirements. This also holds true of gas turbine components to be cleaned that have been operated under extreme conditions.

One advantageous refinement of the present invention provides for the component to be heated from a first process temperature to a second process temperature in the first time interval of between 5 and 20 seconds; to be maintained at this second process temperature in the second time interval of between 10 and 60 seconds; and to be subsequently cooled from the second process temperature to the first process temperature in the third time interval of between 30 and 90 seconds. This is preferably carried out a plurality of times or repeatedly.

Preferred embodiments of the present invention are derived from the dependent claims and from the following description. The present invention is described in greater detail in the following on the basis of exemplary embodiments, without being limited thereto.

The present invention relates to a method for cleaning cavities on gas turbine components, such as on internally cooled gas turbine rotor blades, for example. To clean gas turbine components of this kind, they are preferably examined prior to the cleaning process using an X-ray technique, in order to check or determine the degree of contamination before [initiating] the cleaning process.

Along the lines of the present invention, gas turbine components, namely the cavities thereof, that are to be cleaned, are flooded with inert gas or protective gas. The inert gas or protective gas may be argon, helium, neon, nitrogen, radon, krypton or also xenon, for example. The entire component to be cleaned is preferably positioned in an inert gas or protective gas atmosphere, so that the entire component is surrounded by protective gas and all cavities of the same are flooded with protective gas.

Once it has been flooded with protective gas, the component undergoes a thermal treatment. This thermal treatment is preferably repeated a plurality of times, it essentially being composed of three incremental steps; in a first incremental step, the component being heated to a temperature within a first time interval, in a second incremental step, being maintained at this temperature for a second time interval; and, in a third incremental step, being subsequently cooled in a third time interval. Not until this thermal treatment has been preferably repeatedly carried out, is the cleaning medium and, subsequently thereto, the rinsing medium directed through the or each cavity of the gas turbine component.

As already mentioned, the thermal treatment involves heating the component under inert gas or protective gas atmosphere in the first time interval, from a first process temperature to a second process temperature. The first process temperature, namely the initial temperature for heating the gas turbine component, is between 280° K and 320° K, preferably on the order of the ambient temperature at 295° K. The second process temperature, to which the gas turbine component is heated starting from the first process temperature, is between 1,200° K and 1,300° K, the heating from the first process temperature to the second process temperature being carried out within the first time interval of between 5 and 20 seconds, preferably 15 seconds. Subsequently to the heating to the second process temperature, the gas turbine component is maintained at the second process temperature within the second time interval of between 10 and 60 seconds, preferably 30 seconds. The component is subsequently cooled from the second process temperature, preferably to approximately the first process temperature, in the third time interval lasting between 30 and 90 seconds, preferably 60 seconds.

It follows herefrom that the total time period of a single thermal treatment, respectively of one heating and cooling cycle, is between 45 seconds and 170 seconds, preferably 105 seconds. This thermal treatment is preferably carried out in repeated succession, namely up to ten times, in particular up to six times. By successively heating and cooling the gas turbine component in this manner within the relatively short time intervals, impurities and deposits inside of the cavities thereof are broken up, thereby facilitating their removal from the cavity during the subsequent method steps.

It is also noted here that an induction heating device or a laser heating device may be used for heating the component. It is incumbent upon one skilled in the art whom this technical teaching concerns to select a suitable heating device.

Once the gas turbine component has undergone the preferably repeatedly executed thermal treatment described above, a caustic cleaning medium is directed through the or each cavity of the same. The caustic cleaning medium is a hydroxide solution, preferably a solution of 35% to 45% potassium hydroxide (KOH). The caustic cleaning medium is heated to a temperature of between 333° K and 503° K, and the thus tempered cleaning medium is directed at a pressure of between 18 and 21 bar through the or each cavity to be cleaned of the gas turbine component. In the process, the cleaning medium is directed through the or each cavity of the gas turbine component for a time period of between 480 and 700 minutes.

Following the cleaning medium, the rinsing medium is directed through the or each cavity of the gas turbine component. The rinsing medium is either demineralized or deionized water. The rinsing medium preferably has a temperature of between 278° K and 372° K and is directed at a pressure of between 30 and 600 bar for a time period of between 5 and 30 minutes through the or each cavity of the gas turbine component. In this context, the rinsing medium is pumped at a rate of 0.8 to 301/min through the or each cavity of the gas turbine component.

Once the or each cavity is rinsed with rinsing medium, the component, respectively the or each cavity of the same, is dried with compressed air.

The components cleaned in this manner may then be subsequently inspected or examined, in turn, in an X-ray examination process. The method according to the present invention makes it possible for even highly stressed gas turbine components to be effectively cleaned, and in fact, in such a way that 100% of all of the cleaned components meet the cleaning requirements.

The process of passing cleaning and rinsing medium through the or each cavity of the gas turbine component may be carried out a plurality of times or repeatedly, in the same way as the preceding thermal treatment of the same. The component is treated with cleaning and rinsing medium between one and four times.

1-12. (canceled)

13: A method for cleaning cavities on gas turbine components comprising:
flooding the or each cavity of the gas turbine component with inert gas;
thermally treating the gas turbine component while the inert gas atmosphere is maintained in the or each cavity;
heating the component to a temperature in a first time interval, maintaining the component at the temperature for a second time interval, and subsequently cooling the component in a third time interval; and, subsequently thereto, treating the component with a caustic cleaning medium and, subsequently thereto, rinsing the component with a rinsing medium being repeatedly directed through the or each cavity to be cleaned of a gas turbine component.

14: The method of claim 13, wherein the gas turbine components are gas turbine blades.

15: The method of claim 13 wherein the step of thermal treating the component is repeated a plurality of times.

16: The method as recited in claim 13, wherein, in the first time interval, the step of heating includes heating the component from a first process temperature to a second process temperature; in the second time interval, the step of maintaining includes maintaining the component at this second process temperature; and, in the third time interval, the step of cooling includes subsequently cooling the component from the second process temperature to about the first process temperature.

17: The method as recited in claim 16, wherein the first process temperature is between 280° K and 320° K, and the second process temperature is between 1,200° K and 1,300° K.

18: The method as recited in claim 13, wherein the time period of a single thermal treatment comprising a first, second and third time interval is between 45 and 170 seconds.

19: The method as recited in claim 18, wherein the time period of a single thermal treatment comprising a first, second and third time interval is 105 seconds.

20: The method as recited in claim 18, wherein the first time interval is between 5 and 20 seconds; the second time interval is between 10 and 60 seconds, and the third time interval is between 30 and 90 seconds.

21: The method as recited in claim 20, wherein the first time interval is 15 seconds.

22: The method as recited in claim 20, wherein the second time interval is 30 seconds.

23: The method as recited in claim 20, wherein the third time interval is 60 seconds.

24: The method as recited in claim 13, wherein the step of thermally treating comprises performing the thermal treatment between two and ten times while maintaining the inert gas atmosphere in the or each cavity.

25: The method as recited in claim 24, wherein the step of thermally treating comprises performing the thermal treatment between two and six times while maintaining the inert gas atmosphere in the or each cavity.

26: The method as recited in claim 13, wherein the treating step includes directing a caustic cleaning medium through the or each cavity.

27: The method as recited in claim 26, wherein the caustic cleaning medium is a hydroxide solution.

28: The method as recited in claim 27, wherein the caustic cleaning medium is a 35% to 45% potassium hydroxide solution.

29: The method as recited in claim 27, wherein directing the hydroxide solution having a temperature of between 333° K and 503° K at a pressure of between 18 and 21 bar for a time period of between 480 and 700 minutes through the or each cavity.

30: The method as recited in claim 13, wherein, the rinsing medium is deionized water.

31: The method as recited in claim 13, wherein the rinsing medium is demineralized water.

32: The method as recited in claim 13, wherein the rinsing step includes directing the rinsing medium having a temperature of between 278° K and 372° K at a pressure of between 30 and 600 bar for a time period of between 5 and 30 minutes through the or each cavity.
